(19) United States
(12) Patent Application Publication
(10) Pub. No.: US 2008/0297020 A1
(43) Pub. Date: Dec. 4, 2008

(54) Illuminiation Arrangement

(75) Inventors: Mario Wanninger, Regensburg (DE); Alexander Wilm, Regensburg (DE)

Correspondence Address: FISH & RICHARDSON PC, P.O. BOX 1022, MINNEAPOLIS, MN, 55440-1022, US

(73) Assignee: OSRAM OPTO SEMICONDUCTORS GMBH, Regensburg (DE)

(21) Appl. No.: 12/088,099

(22) PCT Filed: Aug. 14, 2006
(86) PCT No.: PCT/DE2006/001422

§ 371 Date: Jul. 8, 2008

(30) Foreign Application Priority Data
Sep. 30, 2005 (DE) 10 2005 046 941.8
Dec. 23, 2005 (DE) 10 2005 061 798.0

(51) Int. Cl. H01K 1/30

(52) U.S. Cl. 313/110

(57) ABSTRACT

An illumination arrangement (1) is specified, comprising a radiation-emitting diode (2) for generating radiation, a first optical element (5) for beam shaping, a second optical element (6) for beam shaping and an optical axis (4) running through the radiation-emitting diode, wherein the first optical element has a radiation entrance surface (51) and a radiation exit surface (52), the second optical element has a radiation entrance surface (61) and a radiation exit surface (62), the optical axis runs through the first optical element and the second optical element, the radiation exit surface of the first optical element purposely refracts away from the optical axis a radiation portion (71) of radiation (7) generated in the radiation-emitting diode before said radiation portion enters the second optical element, and the radiation exit surface of the second optical element also purposely refracts said radiation portion away from the optical axis.

The present invention is directed to an illumination arrangement comprising a radiation source

Frequently, the radiation source is to be positioned as close as possible to a surface that is to be illuminated by the illumination arrangement. On the one hand, this does make it easier to give a low installed depth to the unit formed by the radiation source and the illuminated surface. On the other hand, however, the subarea of the surface that is directly illuminated by the radiation source often crucially depends on the distance between the radiation source and the surface to be illuminated. The smaller this distance, as a rule, the smaller the area directly illuminated by the radiation source. To illuminate the entire surface, therefore, a plurality of radiation sources is often used, the individual radiation sources each being assigned a particular illumination area on that surface. Thus, in order to obtain a low installed depth for the unit formed by the radiation sources and the illuminated surfaces, it is necessary to figure on using a large number of radiation sources to produce areal illumination. In many cases, however, a smaller number of radiation sources would be sufficient to deliver the radiant power needed for the particular lighting application.

The object of the present invention is to specify an illumination arrangement by means of which, given a predetermined distance between the outcoupling surface of the radiation source and the surface to be illuminated, the size of that surface area of the surface to be illuminated which is illuminated by means of the radiation source can be increased in a simplified manner.

This object is achieved according to the invention by means of an illumination arrangement having the features of claim 1. Advantageous embodiments and improvements of the invention are the subject matter of the dependent claims.

An illumination arrangement according to the invention comprises a radiation-emitting diode for generating radiation, a first optical element for beam shaping, a second optical element for beam shaping and an optical axis running through the radiation-emitting diode. The first optical element and the second optical element each have a radiation entrance surface and a radiation exit surface, and the optical axis runs through the first and the second optical elements. Furthermore, the radiation exit surface of the first optical element refracts away from the optical axis, particularly purposely, a radiation portion of radiation generated in the radiation-emitting diode before said radiation portion enters the second optical element. The radiation exit surface of the second optical element also particularly purposely refracts this radiation portion away from the optical axis.

Such refraction behavior can be obtained by suitable shaping of the relevant surfaces of the first and second optical elements and by suitable arrangement of the optical elements in relation to the radiation source and to each other.

By virtue of the fact that both the first optical element and the second optical element refract radiation purposely and preferably directionally away from the optical axis, it is possible, given a predetermined distance between the radiation-emitting diode and the surface to be illuminated by the illumination arrangement, to increase the size of the area of said surface that is illuminated by the radiation-emitting diode serving as the radiation source. To this end, the first and second optical elements are usefully disposed between the radiation-emitting diode and the surface to be illuminated. The first optical element is preferably disposed between the second optical element and the radiation-emitting diode.

Moreover, twofold refraction of radiation away from the optical axis makes it possible to reduce the fraction of radiant power that strikes the to-be-illuminated surface in the axial direction. This facilitates the illumination of the surface with a uniform distribution of the irradiance—stated in watts of radiant power striking the surface per square meter of impingement area—on the to-be-illuminated region of the surface. This is especially advantageous when the radiation source is a radiation-emitting diode, since a radiation-emitting diode normally emits a relatively large proportion of its radiant power in the axial direction. It is therefore difficult to obtain uniform, large-area illumination of the surface in areas relatively distant from the optical axis with the radiation-emitting diode alone.

Compared to conventional radiation sources, for example incandescent lamps, a radiation-emitting diode is also notable for its advantageous small component size and longer service life. This makes it possible to give the illumination arrangement a reliable and compact construction.

The radiation-emitting diode is preferably configured to generate electromagnetic radiation, particularly preferably in the infrared or ultraviolet region of the spectrum, or as a light-emitting diode, e.g. as an LED component, for generating radiation, particularly incoherent radiation, in the visible region of the spectrum.

The illumination arrangement is also particularly suitable for illuminating a planar surface, to which the optical axis is preferably perpendicular.

In a preferred configuration, the first optical element is configured to increase the beam width of the radiation generated in the radiation-emitting diode and the second optical element is arranged and configured to further increase the beam width of the radiation that has passed through the first optical element. The first optical element thus preferably widens the radiation characteristic of the radiation generated in the radiation-emitting diode, while the second optical element further widens the radiation characteristic already widened by the first optical element. In particular, the radiation characteristic of the illumination arrangement can, in a simplified manner, be shaped to conform to a predefined radiation characteristic by means of the optical elements. The radiation characteristic is preferably shaped so as to yield a uniform lateral distribution of radiant power on the surface to be illuminated by the illumination arrangement. In this case, an angle that the radiation portion refracted away from the optical axis makes with the optical axis after passing through the second optical element can be greater than another angle that this radiation portion makes with the optical axis after passing through the first optical element and preferably before entering the second optical element.

In another preferred configuration, the radiation exit surface of the second optical element and the radiation exit surface of the first optical element are similarly shaped. Such shaping of the refracting radiation exit surfaces of the optical elements makes it easier to obtain a given radiation characteristic on the exit side of the second optical element, since it eliminates the need for the relatively onerous process of matching differently shaped radiation exit surfaces to each other for this purpose. In particular, the radiation exit surfaces of the two optical elements can be geometrically similar to each other, that is, they can be implemented such that they can be mapped onto each other by center extension.

In addition, the radiation entrance and/or exit surface of the second optical element can partially or completely overlap the radiation exit surface of the first optical element. The radiation entrance and/or exit surface of the second optical element can in this case have a lateral extent, in a direction perpendicular to the optical axis, that is greater than that of the radiation exit surface of the first optical element. This facilitates the passage of radiation widened by the first optical element over to the second optical element.

The radiation exit surface of the first optical element is preferably spaced apart from the radiation entrance surface of the second optical element.

In a further preferred configuration, the radiation exit surface of the first optical element has a concavely curved subregion and/or the radiation exit surface of the first optical element has a convexly curved subregion. The second optical element can also be implemented in similar fashion. Shaping of this kind is particularly suitable for comparatively thin and therefore space-saving optical elements, while simultaneously affording good beam widening.

In one advantageous improvement, the convexly curved subregion surrounds the concavely curved subregion laterally, particularly at a distance from the optical axis. An optical element configured in this manner is particularly suitable both for increasing the beam width in a small amount of space and for producing a uniform lateral distribution of irradiance on the surface to be illuminated.

In another advantageous improvement, the first and second optical elements are arranged such that the optical axis runs through the concavely curved subregion of the first optical element and the concavely curved subregion of the second optical element. Twofold beam widening can thus take place in a simplified manner, in such a way that a uniform irradiance distribution is obtained. This applies in particular to subareas of the surface to be illuminated that are relatively far from the optical axis.

In another preferred configuration, the radiation exit surface of the first optical element and the radiation exit surface of the second optical element each have an axis of symmetry, particularly a rotational axis of symmetry. The first optical element and the second optical element are preferably arranged so that the axes of symmetry of the radiation exit surfaces coincide. Particularly preferably, the two optical elements are arranged such that their axes of symmetry and the optical axis coincide. Such an implementation or arrangement of the optical elements in relation to each other or to the radiation-emitting diode further simplifies the homogenization of the irradiance distribution on the surface to be illuminated. Implementing the radiation entrance and/or exit surfaces of the optical element itself (or of the elements themselves) as symmetrical, particularly as rotationally symmetrical, makes it possible to obtain a symmetrical radiation characteristic in a simplified manner. Uniform illumination of the surface is consequently facilitated.

In a further preferred configuration, the radiation entrance surface of the second optical element comprises a recess. The radiation exit surface of the first optical element can extend into the recess. This facilitates compact implementation of the illumination arrangement.

Furthermore, the recess in the radiation entrance surface of the second optical element can partially or completely overlap the radiation exit surface of the first optical element.

In a further preferred configuration, the radiation entrance surface of the second optical element has a concavely curved subregion. The recess can be formed by the concavely curved subregion of the radiation entrance surface. The concavely curved subregion can be implemented in particular as a free-form surface, which is preferably implemented as non-spherically and/or non-aspherically curved.

According to an advantageous improvement, the concavely curved subregion is configured such that radiation from the first optical element strikes the radiation entrance surface of the second optical element substantially perpendicularly in said concavely curved subregion. Refraction from the concavely curved subregion can be prevented by the perpendicular impingement of radiation in this region, brought about by the shaping. The risk of a nonuniformity in the irradiance distribution on the illuminated surface due to refraction from the concavely curved subregion can be reduced by shaping of this kind.

According to another advantageous improvement, the concavely curved subregion of the radiation entrance surface of the second optical element is configured as a refractive surface. The concavely curved subregion is preferably shaped so that radiation is refracted away from the optical axis as it enters the second optical element. The radiation characteristic of the illumination arrangement can thus be widened further in a simplified manner. It is particularly suitable for this purpose to implement the radiation entrance surface of the second optical element, particularly the concavely curved subregion of the radiation entrance surface, as a free-form surface that is shaped to achieve this purpose.

In a further preferred configuration, a gap is configured between the radiation entrance surface of the second optical element and the radiation exit surface of the first optical element.

According to an advantageous improvement, a refractive index matching material is disposed between the radiation entrance surface of the second optical element and the radiation exit surface of the first optical element. This advantageously reduces the risk of radiation losses due to an excessive refractive index mismatch during outcoupling from the first optical element and/or the incoupling of radiation into the second optical element. The refractive index matching material is preferably adjacent the radiation exit surface of the first optical element and the radiation entrance surface of the second. The refractive index matching material can, for example, be disposed in the recess. The refractive index matching material preferably reduces the refractive index differential between the optical elements and the adjacent medium, for example air. Such a refractive index matching material is particularly useful when back-reflection is to be reduced or completely eliminated.

According to another advantageous improvement, the gap between the radiation entrance surface of the second optical element and the radiation exit surface of the first optical element is unfilled by, or in particular is substantially free of, refractive index matching material. For example, a gas, e.g. air, can be disposed in the gap. Because of the greater refractive index differential, such a configuration is particularly suitable when the radiation entrance surface of the second optical element, particularly its concavely curved subregion, is configured as a refractive surface, as explained earlier hereinabove. Refraction from the radiation exit surface of the first optical element can also be increased in this way, compared to a refractive-index-matched transition between the optical elements.

In a further preferred configuration, a refractive index matching material is disposed between the radiation entrance surface of the first optical element and the radiation-emitting diode. The optical coupling of the first optical element to the radiation-emitting diode can thus be improved in a manner corresponding to the above embodiments.

According to an advantageous improvement, one refractive index matching material is disposed between the optical elements and another refractive index matching material is disposed between the radiation-emitting diode and the first optical element.

According to another advantageous improvement, a refractive index matching material is disposed between the first optical element and the radiation-emitting diode, and the gap between the radiation exit surface of the first optical element and the radiation exit surface of the second optical element is unfilled by, or in particular is substantially free of, refractive index matching material. In this way, the radiation characteristic of the illumination arrangement can be widened particularly extensively in a simplified manner, as a result of increased refraction.

In another preferred configuration, the first optical element is integrated in the radiation-emitting diode. For example, the first optical element can be created by suitably shaping an encapsulant of a semiconductor chip of the radiation-emitting diode, in which encapsulant the semiconductor chip is preferably embedded.

In another preferred configuration, the first optical element, particularly as a separate optical element, is attached to the radiation-emitting diode. The second optical element can also be attached, particularly as a separate optical element, to the radiation-emitting diode. The optical elements can thus advantageously be fabricated relatively independently of the structure of the radiation-emitting diode. The illumination arrangement can in particular be implemented as a component comprising first and/or second optical elements mounted on the radiation-emitting diode.

A surface-mountable radiation-emitting diode is, moreover, particularly suitable for a compact illumination arrangement.

In a further preferred configuration, the first optical element and the second optical element are implemented as discrete optical elements. The optical elements can thus advantageously be shaped independently of each other.

In another preferred configuration, the first optical element is pre-mounted on the second optical element. Such a composite of the two optical elements facilitates the mounting and alignment of the optical elements relative to the radiation-emitting diode. The pre-mounted and pre-aligned composite can in a simplified manner be attached to the radiation-emitting diode and aligned.

In another preferred configuration, the radiation-emitting diode and the second optical element are mounted on a common carrier element. Alternatively or additionally, the radiation-emitting diode and the first optical element can also be mounted on such a common carrier element. In particular, the first optical element, the second optical element and/or the radiation-emitting diode can have a common mounting plane, for instance the plane of the carrier element. The carrier element can, for example, be implemented as a circuit board. The individual elements of the illumination arrangement can thus be mounted on the carrier element independently of one another.

In another preferred configuration, the illumination arrangement comprises a plurality of radiation-emitting diodes. The radiant power available for illumination purposes can thus be increased in a simplified manner. In addition, mixed-color light can be produced more easily with a plurality of radiation-emitting diodes.

To this end, the radiations generated by the radiation-emitting diodes advantageously have different, particularly different-colored, emission wavelengths in the visible region of the spectrum. For example, the illumination arrangement can comprise one radiation-emitting diode with an emission wavelength in the red, another radiation-emitting diode with an emission wavelength in the green, and yet another radiation-emitting diode with an emission wavelength in the blue region of the spectrum. Light in an extremely wide range of colors, particularly including white light, can be produced by mixing the radiations in a suitable manner.

In another preferred configuration, each radiation-emitting diode has associated with it a particular first optical element and a particular second optical element. Such association makes it easier to obtain a uniform irradiance distribution. The first optical elements are preferably attached to their respective associated radiation-emitting diodes.

In another preferred configuration, each radiation-emitting diode has associated with it a particular first optical element and a single, common second optical element. This makes it easier to arrange the second optical element relative to the first optical elements.

Each first optical element can also have a particular second optical element associated with it. Beam shaping to conform to a predefined radiation characteristic can be simplified in this fashion.

In another preferred configuration, a plurality of second optical elements is implemented as integrated in a device. Where appropriate, the first optical elements can also be implemented as integrated in another device. The alignment of such a device can be effected more simply than separate alignment of the optical elements. The optical elements are preferably arranged and configured in the device in accordance with a predetermined arrangement of the radiation-emitting diodes in the illumination arrangement.

In another preferred configuration, the illumination arrangement is provided for backlighting a display such as an LCD (LCD: Liquid Crystal Display), particularly the direct backlighting of such a device.

The illumination arrangement further is particularly suitable for direct backlighting.

Other features, advantages and utilities of the invention will emerge from the following description of the exemplary embodiments, taken in conjunction with the figures.

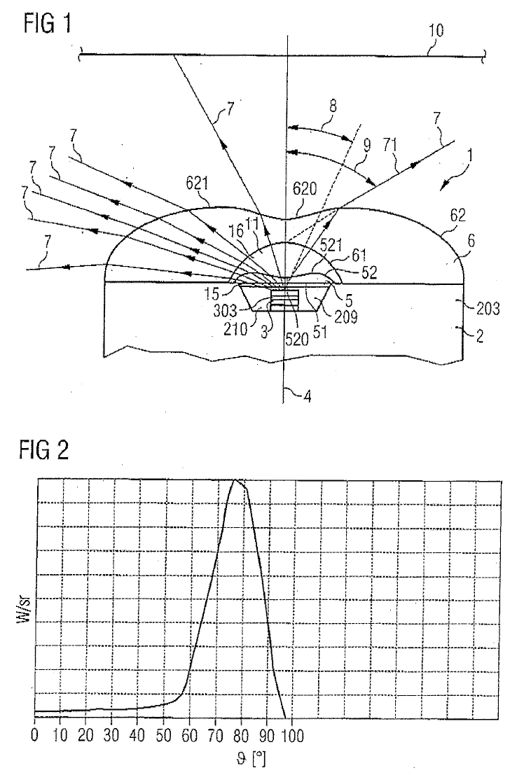

FIG. 1 is a schematic sectional view of a first exemplary embodiment of an illumination arrangement according to the invention,

FIG. 2 shows the radiation characteristic of an illumination arrangement according to the invention,

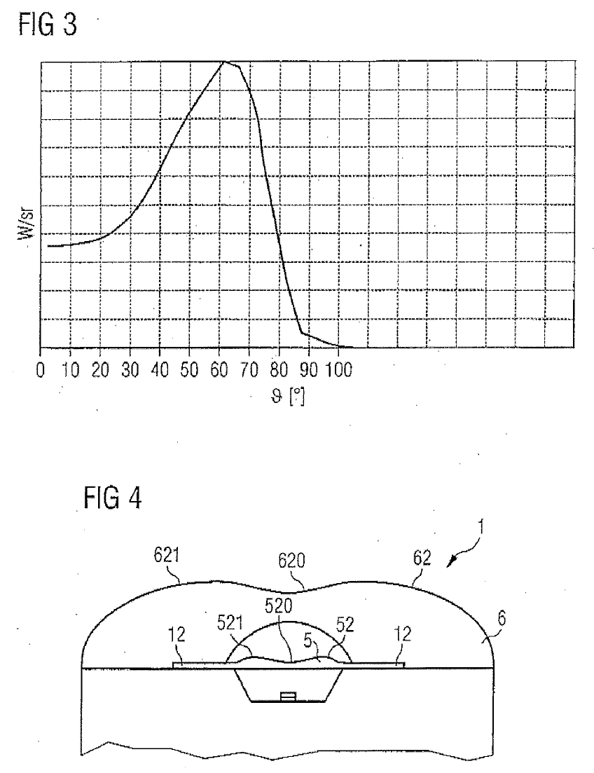

FIG. 3 shows the radiation characteristic of an illumination arrangement comprising only one optical element,

FIG. 4 is a schematic sectional view of a second exemplary embodiment of an illumination arrangement according to the invention,

FIG. 5 is a schematic sectional view of a third exemplary embodiment of an illumination arrangement according to the invention,

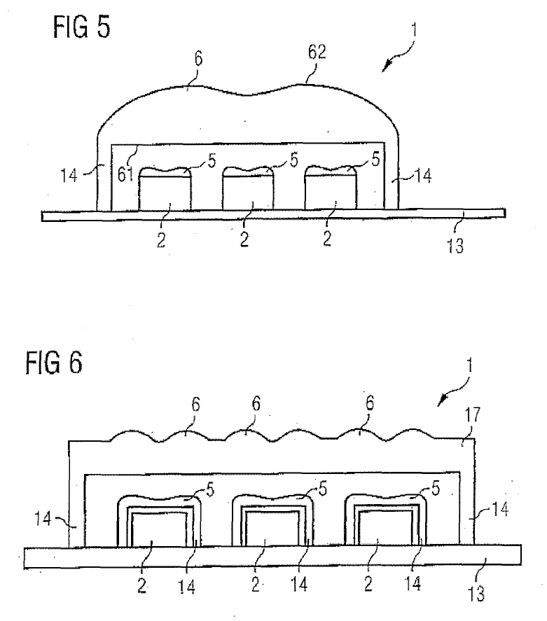

FIG. 6 is a schematic sectional view of a fourth exemplary embodiment of an illumination arrangement according to the invention,

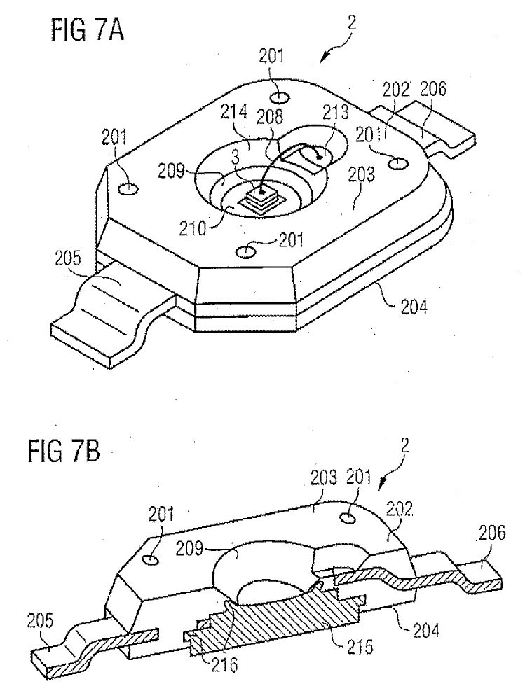

FIG. 7 shows an optoelectronic component that is particularly suitable for use as a radiation-emitting diode 2 in the illumination arrangement, FIG. 7A being a schematic perspective plan view of the component and FIG. 7B a perspective schematic sectional view of the component.

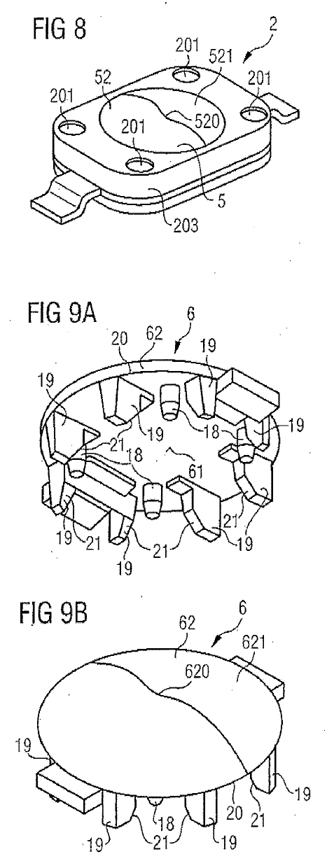

FIG. 8 is a schematic perspective oblique plan view of a radiation-emitting diode,

FIG. 9 provides schematic oblique plan views, in FIGS. 9A and 9B, of an optical element that is particularly suitable for an illumination arrangement, and

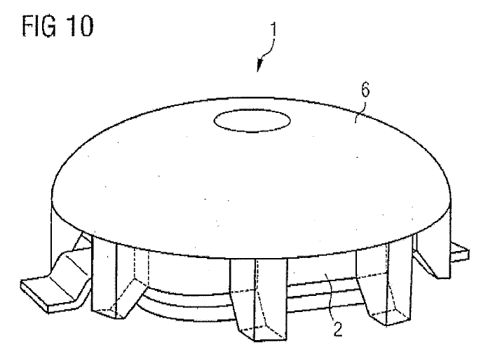

FIG. 10 is a schematic perspective oblique plan view of a fifth exemplary embodiment of an illumination arrangement according to the invention.

Like, similar and like-acting elements are provided with the same reference numerals in the figures.

FIG. 1 is a schematic sectional view of a first exemplary embodiment of an illumination arrangement 1 according to the invention.

The illumination arrangement 1 includes a radiation-emitting diode 2 comprising a semiconductor chip 3 for generating radiation. An optical axis 4 runs through the radiation-emitting diode and, in particular, the semiconductor chip. The optical axis 4 can be, for example, substantially perpendicular to the semiconductor chip 3, preferably perpendicular to an active area 303 of the semiconductor chip, which area is provided for generating radiation. A first optical element 5 and a second optical element 6 of the illumination arrangement 1, each of which is implemented for example as a lens, respectively have a radiation entrance surface 51 and 61 and a radiation exit surface 52 and 62. The optical axis 4 runs through first optical element 5 and second optical element 6.

The first and second optical elements are arranged and configured such that radiation 7 generated in the semiconductor chip 3, on leaving the first optical element, is refracted by its radiation exit surface 52 purposely and directionally away from the optical axis 4. To this end, the medium adjacent the first optical element on its radiation exit side, such as air, for example, usefully has a lower refractive index than the material of the first optical element. The radiation 7 then passes through radiation entrance surface 61 into second optical element 6. The material of second optical element 6 preferably has a higher refractive index than the optical medium, for example air, disposed adjacent the second optical element on its radiation entrance side. On exiting through the radiation exit surface 62 of second optical element 6, the radiation is also refracted away from the optical axis 4.

This is clarified by radiation portion 71. An angle 8 that this radiation portion makes with the optical axis 4 after passing through the first optical element 5 and before entering the second optical element 6 is smaller than another angle 9 that this radiation portion makes with the optical axis after passing through the second optical element.

The first and second optical elements 5 and 6 are each configured to increase the beam width of the radiation 7 generated in the semiconductor chip 3, the pre-widened radiation that has already passed through first optical element 5 being widened further by second optical element 6. The width of the radiation characteristic of the illumination arrangement 1 is thereby increased twice in comparison to the radiation characteristic of the semiconductor chip 3 or of the radiation-emitting diode 2.

Given a predetermined distance from an outcoupling surface of the illumination arrangement 1, which in the present exemplary embodiment is formed by the radiation exit surface 62 of the second optical element 6, that subarea of a, particularly planar, surface 10 to be illuminated which is illuminated by the illumination arrangement is increased in size via refraction by the first and second optical elements. Conversely, given an illuminated subarea having a predetermined surface area, the distance of the outcoupling surface of the illumination arrangement from surface 10 can be decreased.

Furthermore, the illumination arrangement 1 is configured to produce uniform illumination of the surface 10. To this end, the optical elements 5 and 6 are arranged and configured to yield a predefined radiation characteristic of the illumination arrangement that results in a uniform irradiance distribution on the illuminated subarea of the surface 10. To achieve this, the radiation exit surfaces 52 and 62 of the optical elements respectively each have a concavely curved subregion 520 and 620 through which the optical axis 4 runs. The respective concavely curved subregions 520 and 620 are surrounded at a distance from the optical axis 4 by respective convexly curved subregions 521 and 621. Such shaping of the radiation exit surfaces of the optical elements makes it possible in a simplified manner to increase the size of the area of surface 10 that is illuminated by the radiation 7 generated in the radiation-emitting diode 2, while at the same time permitting a laterally uniform distribution of radiant power on the illuminated surface. Inhomogeneities in the irradiance distribution, i.e., regions in which the radiant power deviates considerably from that in adjacent regions of the illuminated surface, can thus be eliminated. Furthermore, with such shaping of the optical elements, the homogeneity of the radiant power distribution is advantageously independent of the distance from the outcoupling surface of the illumination arrangement to the surface 10. Thus, no inhomogeneities occur as a result of distance variations between surface 10 and the outcoupling surface.

Beam shaping in the optical elements 5 and/or 6 can take place without total reflection and, in particular, exclusively via refractive surfaces. Furthermore, the radiation exit surface of the particular optical element or the optical functional surfaces of the particular optical element can be implemented with no edges. The radiation exit or entrance surfaces can each be implemented as differentiable surfaces. These measures collectively facilitate the creation of a uniform radiant power distribution.

The respective radiation exit surfaces 521 and 621 of first optical element 5 and second optical element 6 are also similarly shaped. This facilitates uniform, large-area illumination of the surface 10.

The optical elements 5 and 6 as such would already be suitable for producing uniform illumination, but the radiation characteristic can be widened further in a simplified manner by using a plurality of optical elements with similarly shaped radiation exit surfaces.

To obtain a uniform symmetrical irradiance distribution on the surface 10, the radiation exit surfaces 52 and 62, respectively, particularly the optical elements 5 and 6, are preferably configured as rotationally symmetrical and are arranged such that the particular axis of rotational symmetry and the optical axis 4 coincide.

It should be noted, in this regard, that the rotationally symmetrical configuration of the optical elements applies essentially to the optical functional surfaces, that is, the elements of the optical element that are provided for beam shaping. Elements that are not used primarily for beam shaping need not necessarily be implemented as rotationally symmetrical.

The convexly curved subregion of the first and/or second optical element preferably has a curvature that is smaller than a curvature of the concavely curved subregion. Furthermore, the surface area of the convexly curved subregion 621, 521 of the radiation exit surface 52, 62 can be greater than that of the concavely curved subregion 620, 520. Regions of surface 10 that are relatively distant from the optical axis can thus be illuminated by the illumination arrangement 1 in a simplified manner. Furthermore, the convexly curved subregion of the particular radiation exit surface can comprise a first and a second region, the curvature of the first region being smaller than the curvature of the second region. The second region is preferably farther from the optical axis or from the concavely curved subregion than the first region. This makes it possible to increase the portion of the radiation that exits the optical element or elements through the more sharply curved second region at a relatively large angle to the optical axis.

FIGS. 2 and 3 make it clear how the radiation characteristic of the illumination arrangement is widened by means of the first and second optical elements.

FIG. 2 shows the radiation characteristic of an illumination arrangement 1 according to FIG. 1, while FIG. 3 shows the radiation characteristic of an illumination arrangement according to FIG. 1 comprising only one optical element, for example second optical element 6. Each graph shows the dependence of the radiant power per solid angle (in W/sr) emitted by the illumination arrangement on the angle θ to the optical axis. The optical elements are configured as rotationally symmetrical with respect to the optical axis, and the radiation characteristic is therefore rotationally symmetrical to θ=0°. In FIG. 2, the radiant power in the axial direction is sharply reduced in comparison to FIG. 3, and the radiation characteristic of the illumination arrangement is additionally widened. The illumination arrangement 1 according to FIG. 1 radiates, in particular, substantially perpendicularly to the optical axis, although the semiconductor chip 3 or the radiation-emitting diode 2 emits the bulk of the radiant power in the axial direction. Furthermore, the illumination arrangement according to FIG. 1 also emits into the back half-space, i.e., a significant portion of the radiation leaves the illumination arrangement at an angle θ to the optical axis of more than 90°. Hence, the optical elements distribute the radiation generated by the radiation-emitting diode laterally. The radiation generated in a top emitter such as the radiation-emitting diode can be shaped by the optical elements in such a way that the illumination arrangement radiates essentially laterally.

In the exemplary embodiment according to FIG. 1, the radiation exit surface 52 of the first optical element 5 is disposed in a recess 11 in the radiation entrance surface 61 of second optical element 6. Recess 11 is implemented as a, particularly aspherically, concavely curved subregion of the radiation entrance surface 61. The radiation entrance surface is implemented as a free-form surface, especially in the region of the recess and/or of the concavely curved subregion located on the radiation entrance side.

The curvature can be so selected that radiation exiting the first optical element 5 in the region of the recess 11 strikes the radiation entrance surface 61 of second optical element 6 perpendicularly. Refraction from the radiation entrance surface 61 can thus be at least diminished, or eliminated. This simplifies the matching of the optical elements to each other for purposes of uniform illumination of the surface 10.

Alternatively, the radiation entrance surface can be implemented, particularly in the region of the recess, as a refractive surface that refracts radiation away from the optical axis as it enters the second optical element. This configuration of the radiation entrance surface of the second optical element is preferable from the standpoint of increased refraction of radiation away from the optical axis.

Recess 11 completely overlaps the radiation exit surface 52 of first optical element 5 laterally. In addition, second optical element 6 surrounds the first optical element laterally peripherally. This facilitates the passage of radiation from the first into the second optical element.

The semiconductor chip 3 of the radiation-emitting diode 2 is preferably disposed in a cavity 209 in a housing body 203 of radiation-emitting diode 2. An encapsulant 210, in which the semiconductor chip 3 is further preferably embedded, protects the latter against harmful external influences. The encapsulant for example contains a reaction resin, such as an acrylic or epoxy resin, a silicone resin, a silicone, or a silicone hybrid material. The semiconductor chip 3 can, for example, be open-molded with the encapsulant.

Silicone-containing materials, such as a silicone resin, a silicone or a silicone hybrid material, are distinguished by high stability in terms of their optical properties under prolonged exposure to high-energy, short-wave, e.g. blue or ultraviolet, radiation, which preferably can be generated by the semiconductor chip 3. In particular, the risk of yellowing, clouding or discoloration of the encapsulant can be reduced through the use of silicone-based materials, particularly by comparison to an encapsulant containing a reaction resin.

A silicone hybrid material advantageously contains another material in addition to a silicone. A silicone hybrid material can, for example, contain a silicone and a reaction resin, e.g. an epoxy resin. The mechanical stability of the silicone hybrid material, particularly the cured such material, can be increased in this way over that of a non-hybridized silicone.

The radiation-emitting diode 2 is preferably implemented as a surface-mountable component. For the sake of clarity, the connecting leads of the component and the electrical contacting of the semiconductor chip have been omitted from FIG. 1.

In the exemplary embodiment according to FIG. 1, the first optical element 5 and the second optical element 6 are implemented as discrete optical elements. The first and second optical elements are preferably attached to the radiation-emitting diode, particularly to its housing body. For example, the optical elements are each glued or mated onto the radiation-emitting diode.

Gluing is particularly suitable for the first optical element, while mating is particularly suitable for the second. To effect attachment, fastening elements are preferably affixed to the optical element or configured as integrated in the optical element, and engage in corresponding fastening devices that can be configured on the radiation-emitting diode, particularly in the housing body (see FIGS. 7 to 10 in this regard).

The first optical element 5 can be attached to or, where appropriate, integrated into the radiation-emitting diode 2 before the second optical element 6 is affixed to the radiation-emitting diode. Integration into the radiation-emitting diode can be effected, for example, by corresponding shaping of the encapsulant 210, for example during the molding of the encapsulant.

A refractive index matching material 15 can be disposed between the radiation entrance surface 51 of the first optical element 5 and the radiation-emitting diode 2, particularly its semiconductor chip 3. This serves to reduce excessive refractive index mismatches, with the attendant increased reflection at interfaces. For example, the refractive index matching material 15 is disposed between the encapsulant 210 and the radiation entrance surface 51 of the first optical element 5, and is preferably adjacent thereto. A silicone, particularly a silicone gel, is particularly suitable for the refractive index matching material 15.

The first optical element and/or the second optical element preferably contains a synthetic material, e.g. a silicone, a silicone resin, a silicone hybrid material, a PMMA (PMMA: polymethyl methacylate), a PMMI (PMMI: polymethyl methyacrylimide) or a polycarbonate. A silicone hybrid, particularly a cured silicone hybrid, can exhibit higher mechanical stability than a silicone, particularly a non-hybridized and preferably cured silicone.

A silicone, a silicone resin or a silicone hybrid material are particularly suitable for the first optical element. This is true in particular for purposes of optimized radiation hardness and/or optimized refractive index matching to the radiation-emitting diode, in cases where the encapsulant 210 contains a silicone or a material based on silicone and/or the refractive index matching of the first optical element to the radiation-emitting diode is effected by means of a silicone-containing material, e.g. a silicone gel.

Another refractive index matching material 16 can be disposed in the recess 11 between the radiation entrance surface 61 of the second optical element 6 and the radiation exit surface 52 of the first optical element 5. A silicone, particularly a silicone gel, is particularly suitable as the refractive index matching material 16. In this case, the second optical element preferably contains a silicone or a silicone hybrid material for purposes of simplified good refractive index matching.

For strong refraction from the radiation exit surface 52 of the first optical element and preferably the radiation entrance surface 61 of the second optical element, which is preferred in the present case, refractive index matching of the optical elements 5 and 6 to each other is usefully omitted. Hence, a gas, for example air, that makes for a high refractive index differential advantageous for refraction is preferably disposed in the recess 11. In this case, for example in order to achieve particularly high mechanical stability, the second optical element preferably contains no silicone or silicone-based material, but instead, for example, a polycarbonate.

Furthermore, the radiation entrance surface of the first optical element and/or that of the second optical element can be provided with a microstructure or a moth-eye structure. This serves to reduce back-reflection, for instance Fresnel reflection. Such structures can be created in a tool used to shape the optical element, for example a mold, particularly an injection mold.

The illumination arrangement 1 is particularly suitable for backlighting, particularly for directly backlighting, displays, for example symbols or an LCD, while at the same time having a small overall installed size. In the road traffic sector, the illumination arrangement can be used for environmental lighting in vehicle interiors, in traffic signals, as marker lights, for example in tunnels, in rotating beacons, for example on emergency vehicles, or in uniform reflector illumination where a low overall installed depth is required.

The illumination arrangement can also find application in the general lighting field, for example in the effect lighting of ceilings, floors or walls or in environmental lighting. The illumination arrangement is also suitable for large-area incoupling into a light guide placed on the illumination arrangement or for lateral incoupling into a light guide. An illumination arrangement that emits visible radiation is particularly suitable for the aforesaid applications.

An infrared radiation emitting illumination arrangement can be used, for example, in a light barrier or light curtain. The arrangement can also be used in transmitter-receiver units, for example to determine whether the passenger seat is occupied, or as a solar altitude detector. In the case of detector applications, the semiconductor chip is usefully provided to receive radiation or the diode is configured as a photodiode. The optical elements then simplify the reception of radiation from a large range of solid angles.

FIG. 4 is a schematic sectional view of a second exemplary embodiment of an illumination arrangement 1 according to the invention. This exemplary embodiment is substantially the same as that shown in FIG. 1. In contrast thereto, here the first optical element 5 is pre-mounted on the second optical element 6. For example, the first and second optical elements are glued together. The element composite can then be attached to the radiation-emitting diode. For pre-mounting purposes, first optical element 5 comprises one or more mounting elements 12 by means of which the pre-mounting can be performed. The mounting elements can, for example, provide mounting surfaces, for example gluing surfaces. The pre-mounting is usefully done outside the optical functional regions of the optical elements. The convexly curved subregion 521 of the radiation exit surfaces [plural sic] of the first optical element is disposed between the mounting elements 12 and its concavely curved subregion 520.

The mounting element is preferably integrated in first optical element 5. A single mounting element can run laterally around the radiation exit surfaces 52, for example in a ring-like manner.

FIGS. 5 and 6 are schematic sectional views respectively of a third and a fourth exemplary embodiment of an illumination arrangement according to the invention.

The illumination arrangement 1 comprises a plurality of radiation-emitting diodes 2, for example three radiation-emitting diodes, which preferably generate different-colored light, for example red, green and blue light, respectively. The illumination arrangement can thus generate mixed-color light in an extremely wide range of colors.

In FIG. 5, each radiation-emitting diode 2 has associated with it a particular discrete first optical element 5, whereas the radiation-emitting diodes 2 have associated with them a common second optical element 6. The first optical elements 5 are preferably implemented in a similar manner. The radiation entrance surface 61 of the second optical element overlaps the first optical element 5. Furthermore, the radiation-emitting diodes 2 and the second optical element 6 are mounted on a common carrier element 13, for example a circuit board, such as a PCB (PCB: printed circuit board). The second optical element 6 and the radiation-emitting diode 2 are mounted directly on the carrier element and have in particular a common mounting plane. For this purpose, the second optical element comprises mounting bars 14 that preferably extend from the radiation entrance surface 61 toward the carrier element 13. The mounting bars 14 are preferably disposed laterally adjacent the two outermost radiation-emitting diodes of the illumination arrangement. The mounting bars therefore preferably encompass the radiation-emitting diodes. The second optical element is also spaced apart laterally from the radiation-emitting diodes.

In FIG. 6, in contrast to FIG. 5, the individual radiation-emitting diodes 2 each have associated with them particular first and second optical elements 5 and 6, which are preferably implemented respectively in a similar manner, particularly with regard to the radiation exit surfaces. The optical elements 5 and 6 are mounted with the radiation-emitting diodes 2 on a common carrier element 13. The first and/or second optical element and the radiation-emitting diode may have a common mounting plane. The first optical elements also comprise mounting bars 14. For purposes of mounting on the carrier element, the mounting bars of the particular first optical element preferably embrace the radiation-emitting diode associated with that optical element. The first optical element is also preferably spaced laterally apart from the radiation-emitting diode associated with that optical element. A circumferential clearance can, in particular, be formed between the radiation-emitting diode and the optical element.

The second optical elements 6 are in this case integrated in a device 17, for example an optic plate. Where appropriate, the first optical elements 5 can also be integrated in another device. The device is preferably implemented as one-piece.

FIG. 7 depicts an optoelectronic component 2 that is particularly suitable for use as the radiation-emitting diode for the illumination arrangement, FIG. 7A being a schematic perspective plan view of the component and FIG. 7B a perspective schematic sectional view of the component.

Such an optoelectronic component is described in greater detail for example in WO 02/084749, whose disclosure content is hereby explicitly incorporated by reference into the present application. Particularly suitable for use as the radiation-emitting diode is a component similar to that having the type designation LW W5SG (manufacturer: Osram Opto Semiconductors GmbH), or a related or similar component from the same manufacturer.

The optoelectronic component 2 comprises a first electrical connection lead 205 and a second electrical connection lead 206, which can protrude from different lateral surfaces of the housing body 203 of the optoelectronic component 2 and have, for example, a wing-like shape. The component is implemented in particular as a surface-mountable optoelectronic component.

The housing body 203 comprises a cavity 209 in which the semiconductor chip 3 is disposed. The semiconductor chip 3 is embedded in an encapsulant 210. The semiconductor chip 3 is also electrically conductively connected, for example by a solder connection, to connection lead 205. A conductive connection to second connection lead 206 is preferably created via a bonding wire 208. The electrical connection of the bonding wire to second connection lead 206 is preferably made in the region of a bulge 213 in a wall 214 of the cavity 209.

The semiconductor chip 3 is disposed on a thermal connection part 215, which functions as the chip carrier. The thermal connection part extends in the vertical direction preferably from the cavity 209 to the second main surface 204 of the housing body 203 and facilitates thermal connection, particularly large-area thermal connection compared to the area of the chip mounting surface on the thermal connection part, of the semiconductor chip 3, on the second main surface side, to a heat conducting device, for example a heat sink, e.g. made of Cu. Thermal stress on the housing body can thus advantageously be reduced, particularly when the component is operated as a high-power component. The optoelectronic component can be configured to generate a high radiant power, accompanied at the same time by advantageously improved heat dissipation as a result of the thermal connection part. Such an optoelectronic component is particularly suitable for an illumination arrangement.

The thermal connection part 215 is, for example, coupled to a lug of first connection lead 205 or is otherwise laterally peripherally connected to the first connection lead, particularly electrically conductively and/or mechanically. Second connection lead 206, which is provided for contacting by means of bonding wire 208, is preferably elevated above the chip mounting plane of the semiconductor chip 3 on thermal connection part 215. The area of the wall of the cavity that is available for reflecting radiation is kept advantageously large in this way. The housing body 203 can, for example, be made of a material that is a good reflector, for example white plastic. Where appropriate, the housing body can be coated, especially in the region of the cavity, with a reflection-enhancing material, for example a suitable metal. Furthermore, the thermal connection part 215 itself can be implemented as reflective, in which case it preferably forms part of the floor and/or wall of the cavity 209. Moreover, on the side comprising the second main surface, the thermal connection part can protrude from the housing body or terminate substantially flush with the housing body. The thermal connection part comprises, for example, a metal having a high thermal conductivity, such as Cu or Al, or an alloy, such as a CuW alloy.

During the production of such an optoelectronic component in a suitable molding process, for example an injection molding process, a leadframe comprising the two connection leads 205 and 206 and thermal connection part 215 can be enshrouded with the material of the housing body, e.g. a plastic. After the production of the housing body, the semiconductor chip is disposed on or in the premolded housing. The thermal connection part 215 is preferably configured with one or more bulges or convexities 216, thereby improving the mechanical fixation of the thermal connection part to the housing body and thus increasing the overall stability of the optoelectronic component.

Configured on the side of the housing body comprising first main surface 202 are fastening devices 201 provided for attaching an optical element, which optical element can, for example, form the first or second optical element according to the exemplary embodiments described earlier hereinabove. To attach the optical element to the housing body 203, for example four fastening devices 201 can be provided, which facilitate mechanically stable attachment of the optical element to the component. The fastening devices 201 are usefully disposed in the corner regions of the first main surface 202 of the housing body 203. The fastening devices can extend as openings from the first main surface into the housing body. The fastening devices preferably extend all the way to the second main surface of the housing body.

FIG. 8 is a schematic perspective oblique plan view of a radiation-emitting diode 2 configured similarly to that illustrated in FIG. 7. Attached to the radiation-emitting diode 2 is first optical element 5, whose radiation exit surface 52 comprises concavely curved subregion 520 and convexly curved subregion 521. First optical element 5 is, for example, glued to the radiation-emitting diode 2. The second optical element can then be attached to the radiation-emitting diode 2. The second optical element can, for example, be mated onto radiation-emitting diode 2, in which case fastening elements of the optical element preferably engage in the fastening devices 201 of radiation-emitting diode 2. The fastening devices 201 are preferably configured as openings that completely penetrate the housing body and are surrounded laterally by material of the housing body.

FIG. 9 provides schematic oblique plan views, in FIGS. 9A and 9B, of a second optical element 6 that is particularly suitable for a radiation-emitting diode 2, particularly one configured as illustrated in FIG. 7 or 8. The illustrated optical element is also suitable to be used additionally or alternatively, where appropriate, as the first optical element. FIG. 9A is a schematic oblique plan view of the radiation entrance surface 61 and FIG. 9B a schematic oblique plan view of the radiation exit surface 62 of the optical element 6. The optical element 6 comprises a plurality of fastening elements 18, configured for example in a pin-like manner. These fastening elements can engage in the fastening devices 201 of the radiation-emitting diode 2 according to FIG. 7 or 8. For this purpose the optical element can, for example, be attached to the radiation-emitting diode by press-fitting. Where appropriate, a glue can also be applied to the fastening elements 18 alternatively or additionally, to effect adhesive bonding. The fastening elements 18 are affixed to the radiation entrance surface 61 of the optical element or are integrated into the optical element. The optical element and the fastening elements can thus be implemented in one piece. The second optical element 6 further comprises a plurality of marginally disposed guide elements 19. These facilitate the placement or mating of the optical element 6 on or onto the radiation-emitting diode 2, particularly by machine. To this end, the fastening elements are provided on a side that faces away from the edge 20 of the optical element and comprises a bevel 21. When the optical element 6 is placed on the radiation-emitting diode 2, the guide elements preferably enter into direct mechanical contact with the housing body 203 of the radiation-emitting diode, the bevels 21 being configured such that the fastening elements 18, if placed slightly out of alignment with the fastening devices 201, are guided to said fastening devices 201.

In the optical elements illustrated in FIGS. 5, 6 and 9, the radiation entrance surface 61 can, where appropriate, comprise a concavely curved subregion like that of the second optical elements 6 illustrated in FIGS. 1 and 4.

FIG. 10 is a schematic perspective oblique view of a fifth exemplary embodiment of an illumination arrangement 1 according to the invention comprising the radiation-emitting diode 2, which is configured for example according to FIG. 8 and is provided with a first optical element 5, and onto which second optical element 6 is mated.

This patent application claims the priorities of German Patent Applications DE 10 2005 046 941.8 of Sep. 30, 2005, and DE 10 2005 061 798.0 of Dec. 23, 2005, whose entire disclosure content is hereby explicitly incorporated by reference into the present patent application.

The invention is not limited by the description provided with reference to the exemplary embodiments. Rather, the invention encompasses any novel feature and any combination of features, including in particular any combination of features recited in the claims, even if that feature or combination itself is not explicitly mentioned in the claims or exemplary embodiments.

1. An illumination arrangement (1), comprising a radiation-emitting diode (2) for generating radiation, a first optical element (5) for beam shaping, a second optical element (6) for beam shaping, and an optical axis (4) running through said radiation-emitting diode, wherein
said first optical element has a radiation entrance surface (51) and a radiation exit surface (52),
said second optical element has a radiation entrance surface (61) and a radiation exit surface (62),
said optical axis runs through said first optical element and said second optical element,
the said radiation exit surface of said first optical element refracts away from said optical axis a radiation portion (71) of the radiation (7) generated in said radiation-emitting diode before said radiation portion enters said second optical element and
the said radiation exit surface of said second optical element refracts said radiation portion away from said optical axis.

2. The illumination arrangement as in claim 1,
characterized in that
said first optical element (5) is configured to increase the beam width of the radiation generated in said radiation-emitting diode, and said second optical element (6)¹ is arranged and configured to further increase the beam width of the radiation having passed through said first optical element.
¹ Translators Note: The German text has reference numeral (6) misplaced, putting it after “increasing the beam width” (Strahlaufweitung).

3. The illumination arrangement as in claim 1 or 2,
characterized in that
an angle (9) made by said radiation portion (71) with said optical axis (4) after passing through said second optical element is greater than another angle (8) made by said radiation portion with said optical axis after passing through said first optical element and before entering said second optical element.

4. The illumination arrangement as in at least one of the preceding claims,
characterized in that
the said radiation exit surface (62) of said second optical element (6) and the said radiation exit surface (52) of said first optical element (5) are similarly shaped.

5. The illumination arrangement as in at least one of the preceding claims,
characterized in that
the said radiation exit surface (52) of said first optical element (5) has a concavely curved subregion (520).

6. The illumination arrangement as in at least one of the preceding claims,
characterized in that
the said radiation exit surface (62) of said second optical element (6) has a concavely curved subregion (620).

7. The illumination arrangement as in at least one of the preceding claims,
characterized in that
the said radiation exit surface (52) of said first optical element (5) has a convexly curved subregion (521).

8. The illumination arrangement as in at least one of the preceding claims,
characterized in that
the said radiation exit surface (62) of said second optical element (6) has a convexly curved subregion (621).

9. The illumination arrangement as in claims 5 and 7 or claims 6 and 8,
characterized in that
said convexly curved subregion (521, 621) laterally surrounds said concavely curved subregion (520, 620).

10. The illumination arrangement as in claims 5 and 6, characterized in that
said optical axis (4) passes through the said concavely curved subregion (520) of said radiation exit surface (52) of said first optical element (5) and through the said concavely curved subregion (620) of said radiation exit surface (62) of said second optical element (6).

11. The illumination arrangement as in at least one of the preceding claims,
characterized in that
the said radiation exit surface (52) of said first optical element (5) and that (62) of said second optical element (6) each have an axis of symmetry.

12. The illumination arrangement as in claim 11,
characterized in that
said first optical element (5) and said second optical element (6) are arranged such that the axes of symmetry of said radiation exit surfaces (52, 62) coincide.

13. The illumination arrangement as in claim 11,
characterized in that
both of said optical elements (5, 6) are arranged such that the axes of symmetry of said radiation exit surfaces (52, 62) and said optical axis (4) coincide.

14. The illumination arrangement as in at least one of the preceding claims,
characterized in that
the said radiation exit surface (61) of said second optical element (6) comprises a recess (11) and the said radiation exit surface (52) of said first optical element (5) extends into said recess.

15. The illumination arrangement as in claim 14,
characterized in that
said recess (11) partially or completely overlaps the said radiation exit surface (52) of said first optical element (5).

16. The illumination arrangement as in at least one of the preceding claims,
characterized in that
the said radiation entrance surface (61) of said second optical element (6) has a concavely curved subregion that is implemented in particular as a free-form surface.

17. The illumination arrangement as in claims 14 and 16, characterized in that
said recess is formed by the said concavely curved subregion of said radiation entrance surface (61).

18. The illumination arrangement as in at least one of the preceding claims,
characterized in that
the said radiation exit surface (52) of said first optical element (5) is spaced apart from the said radiation entrance surface (61) of said second optical element (6).

19. The illumination arrangement as in at least one of the preceding claims,
characterized in that
a refractive index matching material (15) is disposed between the said radiation entrance surface (51) of said first optical element (5) and said radiation-emitting diode (2).

20. The illumination arrangement as in at least one of the preceding claims,
characterized in that
said first optical element (5) is integrated in said radiation-emitting diode (2).

21. The illumination arrangement as in at least one of the preceding claims,
characterized in that
said first optical element (5) is attached to said radiation-emitting diode (2).

22. The illumination arrangement as in at least one of the preceding claims,
characterized in that
said second optical element (6) is attached to said radiation-emitting diode (2).

23. The illumination arrangement as in at least one of the preceding claims,
characterized in that
said first optical element (5) and said second optical element (6) are implemented as discrete optical elements.

24. The illumination arrangement as in at least one of the preceding claims,
characterized in that
said first optical element (5) is pre-mounted on said second optical element (6).

25. The illumination arrangement as in at least one of the preceding claims,
characterized in that
said radiation-emitting diode (2) and said second optical element (6) are mounted on a common carrier element (13).

26. The illumination arrangement as in at least one of the preceding claims,
characterized in that
said radiation-emitting diode (2) and said first optical element (5) are mounted on a common carrier element (13).

27. The illumination arrangement as in at least one of the preceding claims,
characterized in that
said illumination arrangement (1) comprises a plurality of said radiation-emitting diodes (2).

28. The illumination arrangement as in claim 27,
characterized in that
each said radiation-emitting diode (2) has associated with it a particular said first optical element (5) and a particular said second optical element (6).

29. The illumination arrangement as in claim 27 or 28,
characterized in that
a plurality of second optical elements (6) is implemented as integrated in a device (17).

30. The illumination arrangement as in claim 27,
characterized in that
each said radiation-emitting diode (2) has associated with it a particular said first optical element (5) and a single, common said second optical element (6).

31. The illumination arrangement as in at least one of the preceding claims,
characterized in that
said illumination arrangement (1) is provided for backlighting a display.
